(19) United States
(12) Patent Application Publication
(10) Pub. No.: US 2004/0148349 A1
(43) Pub. Date: Jul. 29, 2004

(54) System and method for connecting a plurality of client workstations to a central control station

(76) Inventor: Donald D. Lacy, Utica, OH (US)

Correspondence Address: MERCHANT & GOULD PC, P.O. BOX 2903, MINNEAPOLIS, MN, 55402-0903, US

(21) Appl. No.: 10/353,278

(22) Filed: Jan. 28, 2003

(51) Int. Cl. G06F 15/16

(52) U.S. Cl. 709/205

(57) ABSTRACT

A system for connecting a plurality of computing systems within an educational setting. The system includes a plurality of client workstations, a control unit for configuring the operation of the plurality of client workstations, and a communications network for transmission of data and commands between the control unit and the plurality of client workstations, the communications network is a TCP/IP based communications network. The control unit selectively displays on a first display device attached to the control unit the images displayed on one of the plurality of client workstations. Each of the plurality of client workstations selectively display on a client display device attached to each of the plurality of workstations images generated by the control unit. Finally, each of the plurality of client workstations selectively receive input data generated by the control unit for use as input to an application program executing on each of the plurality of client workstations.

### TECHNICAL FIELD

The present invention relates to a system and method for connecting a plurality of computing systems to share input and control of the workstations. One example application includes a system within an educational setting. In particular, one example system is a system for permitting a central control station to control the operation of one or more client workstations communicating over a wireless communications network.

### BACKGROUND

The use of computer workstations within educational and training systems used in schools, military, commercial, college and university settings has been viewed for a long time as a mechanism to improve the instruction that may be provided to students and trainees. In these settings, a teacher or instructor would benefit from the ability to observe the actions occurring on a student's workstation, to control the inputs provided to a workstation, and to generate a sequence of multimedia data, including video and audio data, that is presented to the student on a workstation display device.

In the past, elaborate wired systems have been needed to be constructed to implement such a system. An example of such a prior system may be found within a commonly assigned U.S. Pat. No. 4,682,164. This system utilizes a large number of physical electrical connections that connect the individual workstations to a central control unit. Such systems require a large infrastructure consisting of these connections to be installed wherever the workstations are to be utilized. In addition, the workstations become difficult to move as the physical connections would need to be moved or changed when a workstation is moved.

Wireless communications networks are now beginning to permit computing systems such as the student workstations to become mobile. If such connections were used in educational settings, the student workstations would become mobile while reducing the infrastructure requirements in that the complex wiring systems of the prior art would not be needed. Wireless networks operate using a shared communications medium rather than a plurality of separate connections. As such, the operation of any such system that combines the functionality of prior art systems with wireless networks would need to address how these signals are transmitted over a shared communications connection. The present invention described herein addresses the limitation of the prior art to create such a wireless system for use in an educational setting.

### SUMMARY

The present disclosure includes a system for permitting a central control station to control the operation of one or more client workstations communicating over an existing wireless communications network used for many purposes as well as a dedicated wireless network used for educational and training activities. The system includes a plurality of client workstations, a control unit for configuring the operation of the plurality of client workstations, and a communications network for transmission of data and commands between the control unit and the plurality of client workstations, the communications network being a TCP/IP based communications network. The control unit selectively displays on a first display device attached to the control unit the images displayed on one of the plurality of client workstations. Each of the plurality of client workstations selectively displays on a client display device attached to each of the plurality of workstations images generated by the control unit. Finally, each of the plurality of client workstations selectively receives input data generated by the control unit for use as input to an application program executing on each of the plurality of client workstations.

The present disclosure also includes a method for connecting a plurality of computing systems to a single wireless network for permitting a control unit to control the operation of a client workstation. The method transmits a plurality of command packets from a control unit to the client workstation to configure the operation of the client workstation; transmits a start display transfer command packet from the control unit to the client workstation to initiate the beginning of a set of video data packets between the control unit and the client workstation; and if the client is configured to accept keystroke command data packets, transmits a plurality of keystroke command data packets from the control unit to the client workstation. The keystroke command data packets correspond to input commands submitted to an application program executing on the client workstation.

### BRIEF DESCRIPTION OF THE DRAWINGS

In the drawings, wherein like reference letters and numerals indicate corresponding elements throughout the several views:

FIG. 1 illustrates a system for permitting a central control station to control the operation of one or more client workstations communicating over a wireless communications network in accordance with the invention;

FIG. 2 illustrates another embodiment of a system for permitting a central control station to control the operation of one or more client workstations communicating over a wireless communications network in accordance with the invention;

FIG. 3 illustrates an embodiment of a general purpose computing system used as part of a system for connecting workstations in accordance with the invention;

FIG. 4 illustrates a set of processing modules utilized within a control unit configured in accordance with an embodiment of the present invention;

FIGS. 5a-5d illustrates a set of processing modules utilized within a control unit operating in various data communication modes in accordance with the present invention;

FIG. 6 illustrates a set of processing modules utilized within a client workstation configured in accordance with an embodiment of the present invention.

FIGS. 7a-7c illustrates a set of processing modules utilized within a client workstation operating in various data communication modes in accordance with the present invention.

FIG. 8 illustrates a operational flow for the operations of a process for communications between workstations according to an example embodiment of the present invention.

### DETAILED DESCRIPTION

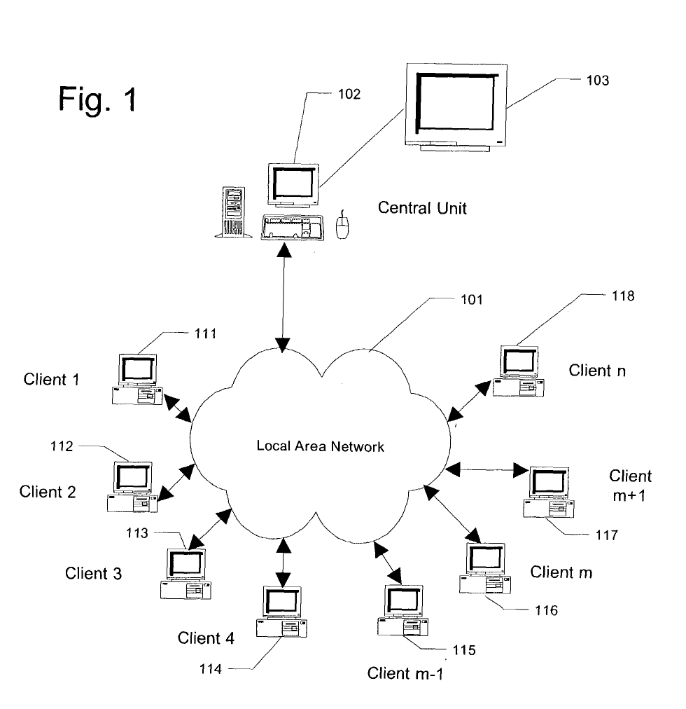

The present invention relates to a system and method for connecting a plurality of computing systems. FIG. 1 illustrates a system for permitting a central control station to control the operation of one or more client workstations communicating over a wireless communications network in accordance with the invention. One example can be an educational setting where the client workstations correspond to student workstations. Such a system includes a central unit 102 that is connected to a local area communications network 101. A plurality of student workstations 111-118 are also connected to the local area network 101 to permit transmission of data between the central unit 102 and one or more of the student workstations 111-118. In a preferred embodiment, this communications network is a wireless communications network such as one constructed using the IEEE 802.11a or 802.11b wireless communications standard. One skilled in the art will, of course, recognize that other communication protocols and other communications media such as wired Ethernet, IR communications networks, and similar communications mechanisms may be used without deviating from the spirit and scope of the present invention as recited within the attached claims.

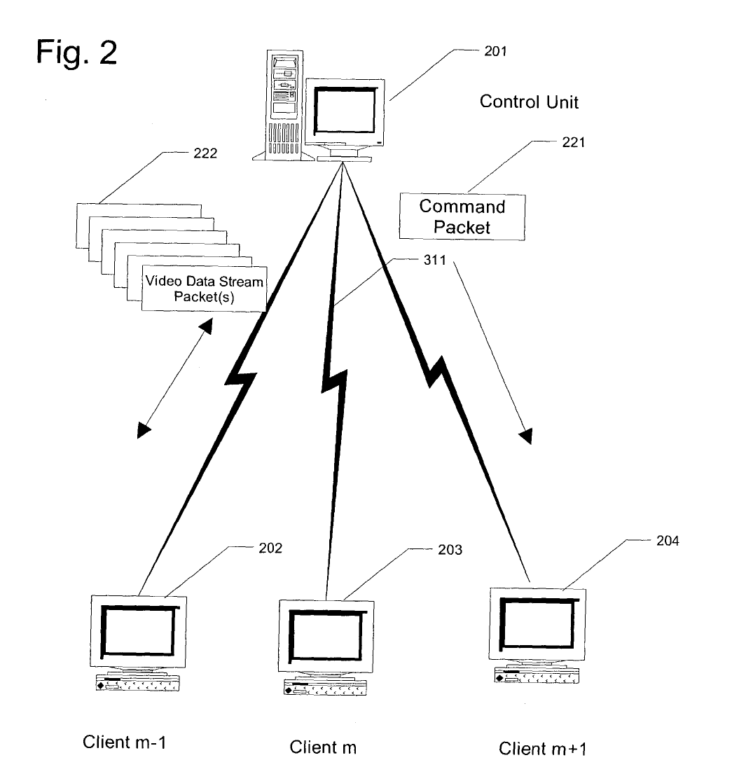

FIG. 2 illustrates another embodiment of a system for permitting a central control station to control the operation of one or more client workstations communicating over a wireless communications network in accordance with the invention. This embodiment of the system includes a control unit 201 and three client workstations 202-204. The control unit 201 configures the operation of one or more of the workstations 202-204 by transmitting a command packet 221 to each of the workstations 202-204 that are to be configured. These commands may be either a sequence of command packets to each individual workstation or a broadcast command packet to all of the workstations.

Once the workstations have been configured, the control unit 201 may initiate the transmission of data, such as a sequence of video data stream packets between the control unit 201 and at least one of the workstations 202-204. This sequence of data may flow between these units for a fixed period of time, or sequence of video images, or until a command packet 221 is transmitted to terminate the data transfer.

The data packets may be transmitted in either direction between a control unit 201 and a client workstation 202 to allow a teacher to see the images present on a student's workstation 202 or to allow a teacher to generate the images that are presented to the student. This data may also include commands that allow a control unit 201 to provide input to a workstation 202 that appears to an application running on the workstation 202 to have been generated by a keyboard or mouse input. As such, a teacher may remotely control a student workstation's operation using the control unit 201 to provide input expected by a program executing on the workstation 202.

Because the communications network typically utilizes a TCP/IP communications protocol, the individual workstations 202-204 are functionally identified by the control unit 201 using each workstation's individual IP address. TCP/IP is the well known Transmission Control Protocol—Internet Protocol. TCP/IP is the common language of the Internet and most other computer networks, and by using it, computers of many different kinds may communicate. As such, any number of workstations may be added to the network as long as unique addresses are available. All command packets are transmitted to a particular workstation by sending the packet to a particular IP address. While other workstations will receive the packet, only the workstation that has the corresponding IP address will process the command packet. Using this configuration, the operation of the system as disclosed below may occur.

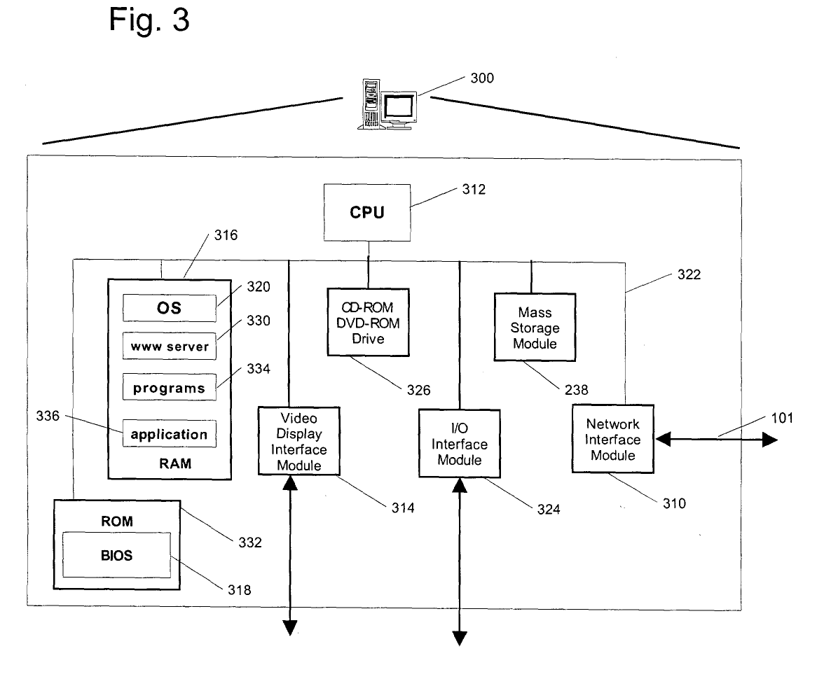

FIG. 3 illustrates an embodiment of a general purpose computing system used as part of a system for configuring an wireless network circuit in accordance with the invention. As shown in FIG. 3, the master controller processing system 300 is connected to a WAN/LAN 101, or other communications network, via network interface unit 310. Those skilled in the art will appreciate that network interface unit 310 includes the necessary circuitry for connecting a processing system to WAN/LAN 101, and is constructed for use with various communication protocols including the TCP/IP protocol. Typically, network interface unit 310 is a card contained within the processing system 300.

The processing system 300 also includes processing unit 312, video display adapter 314, and a mass memory, all connected via bus 322. The mass memory generally includes RAM 316, ROM 332, and one or more permanent mass storage devices, such as hard disk drive 328, a tape drive (not shown), CD-ROM/DVD-ROM drive 326, and/or a floppy disk drive. The mass memory stores operating system 320 for controlling the operation of master controller processing system 300. It will be appreciated that this component may comprise a general purpose server operating system as is known to those skilled in the art, such as UNIX, LINUX™, MAC OS®, or Microsoft WINDOWS NT®. Basic input/output system (“BIOS”) 318 is also provided for controlling the low-level operation of master controller processing system 300.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a master controller processing and network development. More specifically, the mass memory stores applications including master controller processing module 330, programs 334, and other applications 336. Processing module 330 includes computer executable instructions which, when executed by master controller processing system 300, performs the logic described above.

Master controller processing system 300 also comprises input/output interface 324 for communicating with external devices, such as a mouse, keyboard, scanner, or other input devices not shown in FIG. 3. Likewise, master controller processing system 300 may further comprise additional mass storage facilities such as CD-ROM/DVD-ROM drive 326 and hard disk drive 328. Hard disk drive 328 is utilized by master controller processing system 300 to store, among other things, application programs, databases, and program data used by master controller processing module 330. For example, customer databases, product databases, image databases, and relational databases may be stored. The operation and implementation of these databases is well known to those skilled in the art.

One skilled in the art may readily recognize that a Master controller processing system 300 may possess only a subset of the components described above without deviating from the spirit and scope of the present invention as recited within the attached claims. For example, in one embodiment, the mass storage devices for the master controller processing system 300 may be eliminated with all of the data storage being provided by solid state memory. Programming modules may be stored in ROM or EEPROM memory for more permanent storage where the programming modules consist of firmware that is loaded or updated infrequently. Similarly, as an embedded processing system, many of the user interface devices such as input devices and display devices may also not be present.

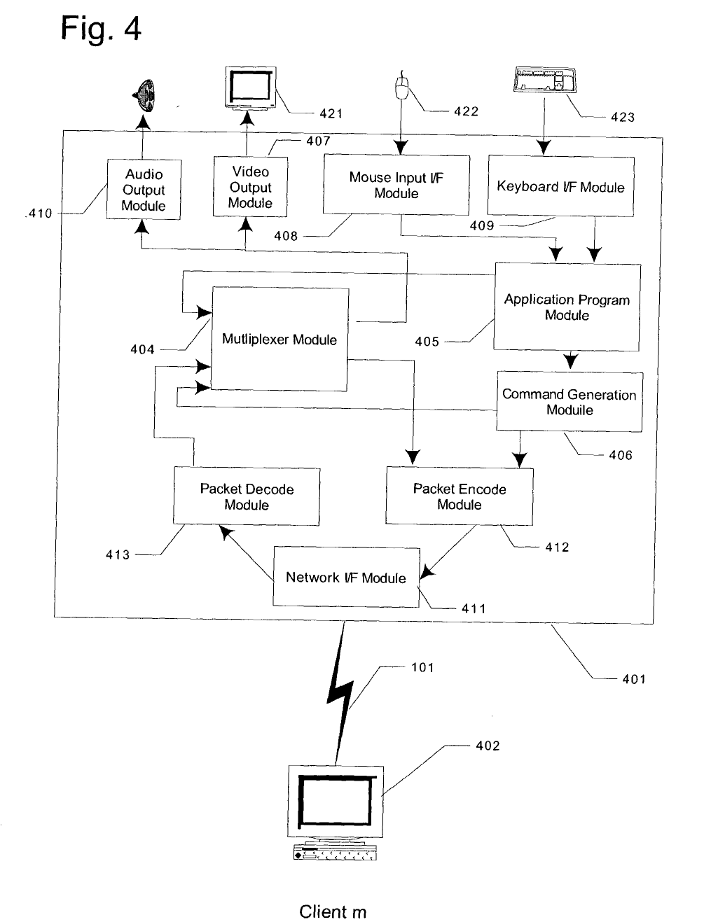

FIG. 4 illustrates a set of processing modules utilized within a control unit configured in accordance with an embodiment of the present invention. The processing modules within the control unit include a network interface module 411, a packet encode module 412, a packet decode module 413, a multiplexer module 404, an application program module 405, a command generation module 406, a video output module 407, an audio output module 410, a mouse input interface module 408, and a keyboard interface module 409. These modules operate together to provide the functions of the control unit 401 as it configures client workstations 402 as well as transmits and receives data with the client workstation 402. For the embodiment described herein, the operations of the control unit are constructed as a set of independent modules that transfer data between themselves. Of course, other arrangements of computing software architectures may be used without deviating from the spirit and scope of the present invention as recited in the attached claims.

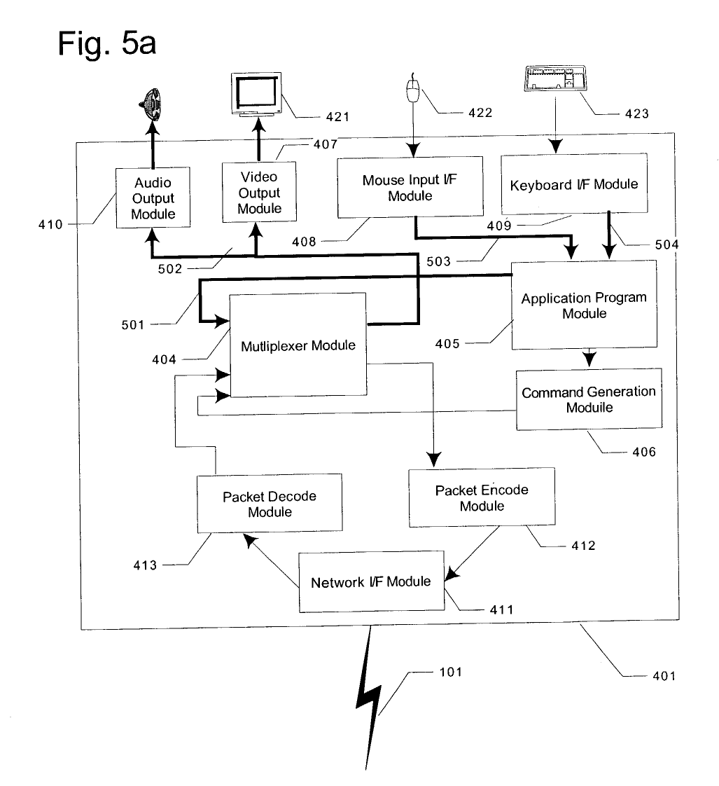

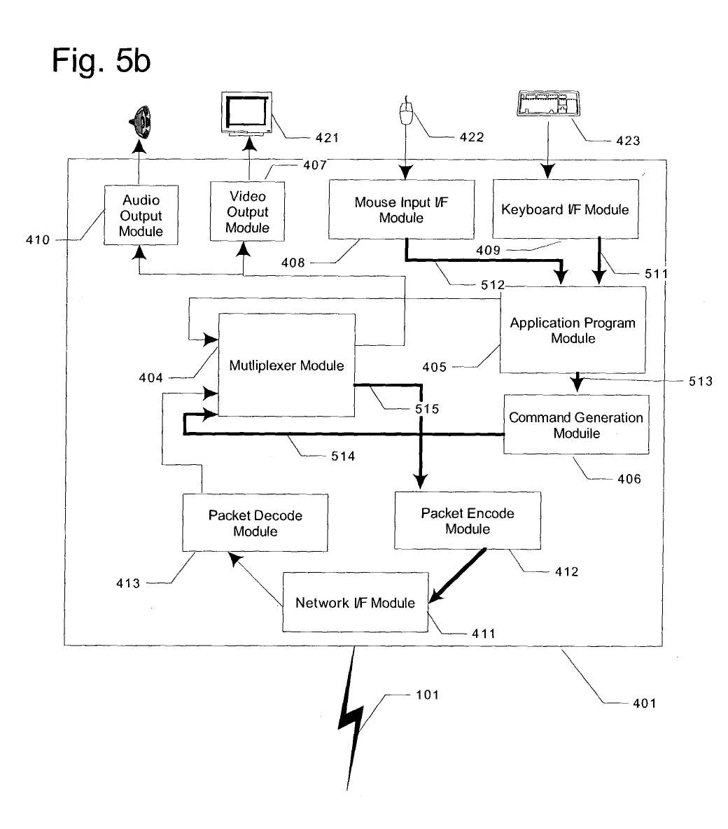

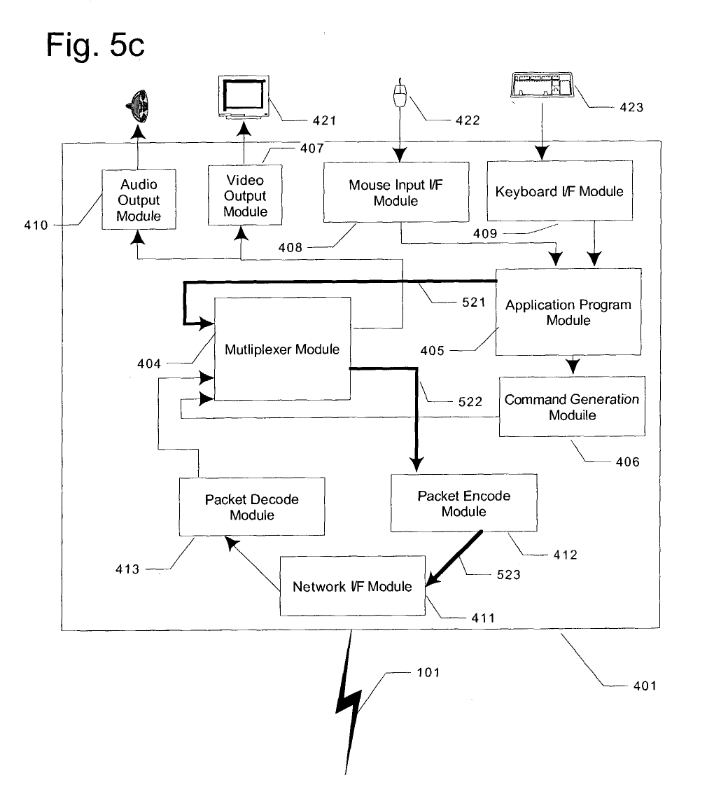

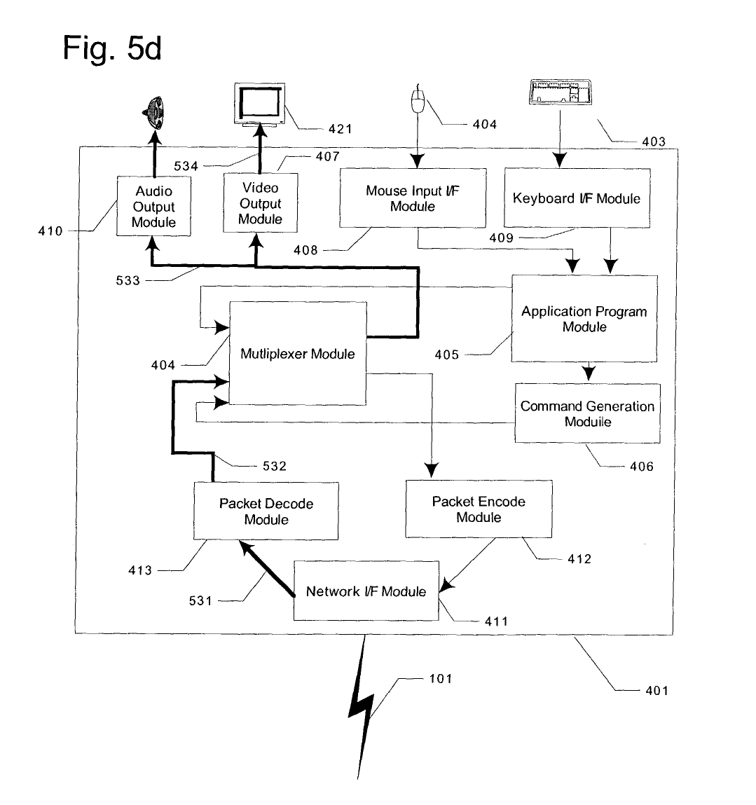

The operation of the individual modules are described below. These modules are used, as discussed in reference to FIG. 5 below to configure the operation of the control unit in various operating modes. These modes correspond to the modes in which the control unit may be used to communicate with the client workstations according to the present invention.

The network interface module 411 receives all data packets that are transmitted over the communications network from the client workstations 402. Only packets with the IP address corresponding to the IP address for the control unit are processed by the module 411 to use by other modules within the control unit 401. The network interface module 411 also transmits all data and command packets that are transmitted over the communications network to the client workstations 402.

The packet encode module 412 processes outgoing data and command packets that are to be transmitted by the network interface module 411 to a client workstation 402. This module 412 typically would be responsible for translating an identifier of a client workstation into its IP address. Additionally, the packet encode module 412 will encode commands that are sent to client workstations 402 into the appropriate command packet. Similarly, the packet decode module 413 processes incoming data packets that are received by the network interface module 411 from a client workstation 402. The packet decode module 413 determines if the data corresponds to various types of data, such as video, keyboard commands, mouse commands, or similar command data, that is to be sent to an appropriate module within the control unit 401 for further processing.

The multiplexer module 404 receives data decoded by the packet decode module 413 and routes it to the appropriate module within the control unit 401 that will process the incoming data. The multiplexer module 404 also routes outgoing data from various modules within the control unit 401 to the packet encode module 412 for transmission to a client workstation. The operation of the multiplexer module 404 is best understood in light of the examples found within FIG. 5.

The application program module 405 corresponds to any application program that is to be executed on the control unit 401 that may generate output video data that is to be sent to a client workstation 402. The command generation module 406 generates commands that become command packets within the packet encode module 412 that are used to configure the operation of the client workstations 402. This module 406 also configures the operation of the multiplexer module 404 to control the data flow within the control unit 401.

The video output module 407 receives video data from either the application program module 405 that is generated within the control unit 401 or a client workstation 402 that has been transmitted over the communications network. The video output module 407 processes the data into a form that may be displayed upon an external video display device 405. This video output module 407 may be merely a video buffer and corresponding set of video drivers. This module 407 may alternatively process the video data for inclusion within a smaller window within the image displayed on the external video display device 421. Similarly, audio data is processed in the same manner as the video data described above using module 410. Of course, the audio and video data may be encoded into a multimedia data stream that is processed as a single set of data that is separated for output at the display device before output to a user.

The mouse input interface module 408 receives mouse input commands from an external pointing device such as a mouse, trackball, and digitizing pad 422. This input command is passed to the application program module for use in controlling its operation. Similarly, the keyboard interface module 409 receives input keystroke commands from an external input device such as a keyboard 423 that are also passed to the application program module for use in controlling its operation.

FIGS. 5a-5d illustrates a set of processing modules utilized within a control unit operating in various data communication modes in accordance with the present invention. FIG. 5a illustrates the operation of the control unit 401 when it is in a local operating mode. FIG. 5b illustrates the operation of the control unit 401 when it is in a program input data packet generation mode. FIG. 5c illustrates the operation of the control unit 401 when it is in a video data packet generation mode. Finally, FIG. 5d illustrates the operation of the control unit 401 when it is in a video packet receiving mode. In all of these operating modes, the active data transfer path has been indicated with a BOLD line as discussed below.

FIG. 5a illustrates the operation of the control unit 401 when it is in a local operating mode. In this operating mode, all of the processing and data remains within the control unit 401 with no data packets being generated or received with a client workstation 402. Input commands received from a mouse or keyboard are transmitted via data paths 503 and 504 respectively to the application program module 405 for use in its operation. Output data generated by the application program module 405 passes through the multiplexer module 404 using data paths 501 and 502 to reach the video output module 407. The data generated by the application program module 405 is displayed in this operating mode only upon the external video display device 421.

FIG. 5b illustrates the operation of the control unit 401 when it is in a program input data packet generation mode. In this operating mode, program input data packets corresponding to input commands received from a mouse or keyboard are sent to a client workstation to allow the control unit to appear to an application program on the workstation to be providing input data that is generated by a keyboard and mouse. Input command data is transmitted via data paths 511 and 512 respectively to the application program module 405 for use in its operation. The application program module sends via data path 513 the input data to the command generation module 406 for transmission to a client workstation. The input data passes through the multiplexer module 404 using data paths 514 and 515 to reach the packet encode module 412. The packet encode module 412 generates a packet with the IP address corresponding the destination workstation for the data and sends it to the workstation via the network interface module 411.

FIG. 5c illustrates the operation of the control unit 401 when it is in a video data packet generation mode. In this operating mode, program video data packets corresponding to video data generated by the application program module 405 are sent to a client workstation for display on its external display device. Program video data is transmitted via data paths 521 from the application program module 405 to the multiplexer module 404 for routing to the network connection. The data passes through the multiplexer module 404 and uses data path 522 to reach the packet encode module 412. The packet encode module 412 generates a packet with the IP address corresponding the destination workstation for the data and sends it to the workstation via the network interface module 411.

Finally, FIG. 5d illustrates the operation of the control unit 401 when it is in a video packet receiving mode. In this operating mode, program video data packets corresponding to video data generated by a client workstation are sent to the control unit 401 for display on its external display device 421. Program video data is received by the network interface module 411 and transmitted via data paths 531 to the packet decode module 413. The packet decode module determines that the data is video data and passes the data to the multiplexer module 404 via data path 532 for routing to the video output module 407. The output module 407 generates the output images presented to the user on the external display device 421.

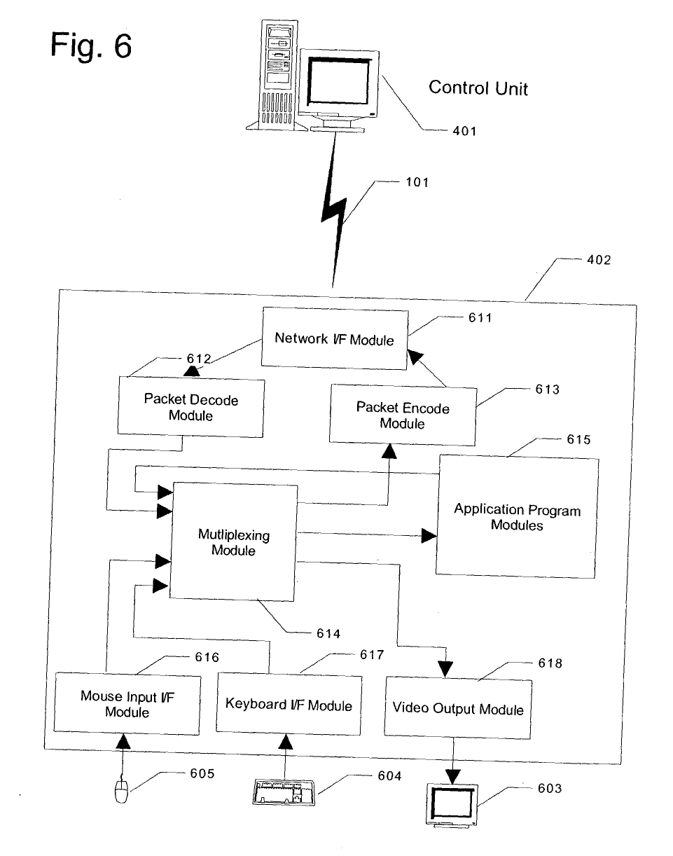

FIG. 6 illustrates a set of processing modules utilized within a student workstation configured in accordance with an embodiment of the present invention. The processing modules within the client workstation include a network interface module 611, a packet encode module 613, a packet decode module 612, a multiplexer module 614, an application program module 615, a video output module 618, a mouse input interface module 616, and a keyboard interface module 617. These modules operate together to provide the functions of the client workstation 402 as it transmits and receives data with the control unit 401. For the embodiment described herein, the operations of the control unit are constructed as a set of independent modules that transfer data between themselves. Of course, other arrangements of computing software architectures may be used without deviating from the spirit and scope of the present invention as recited in the attached claims.

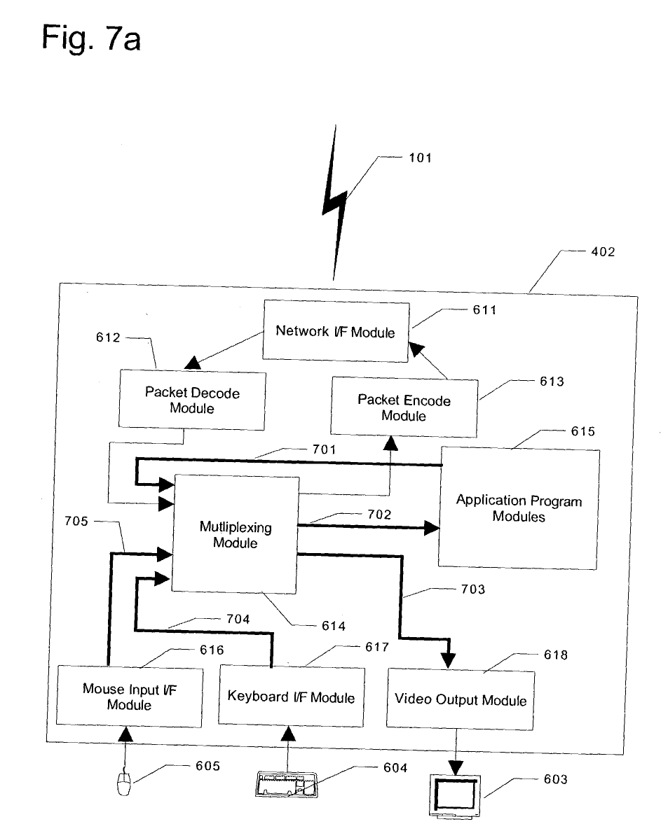

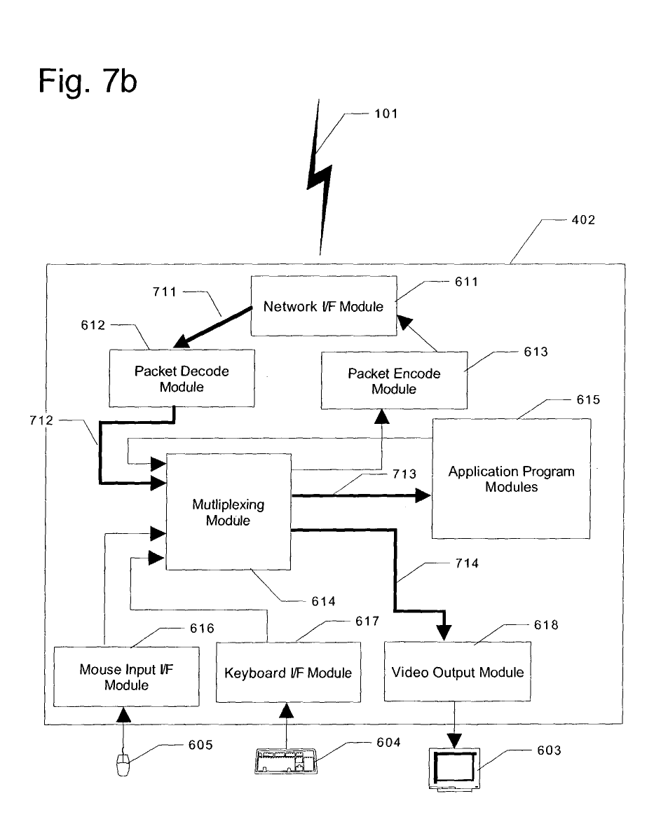

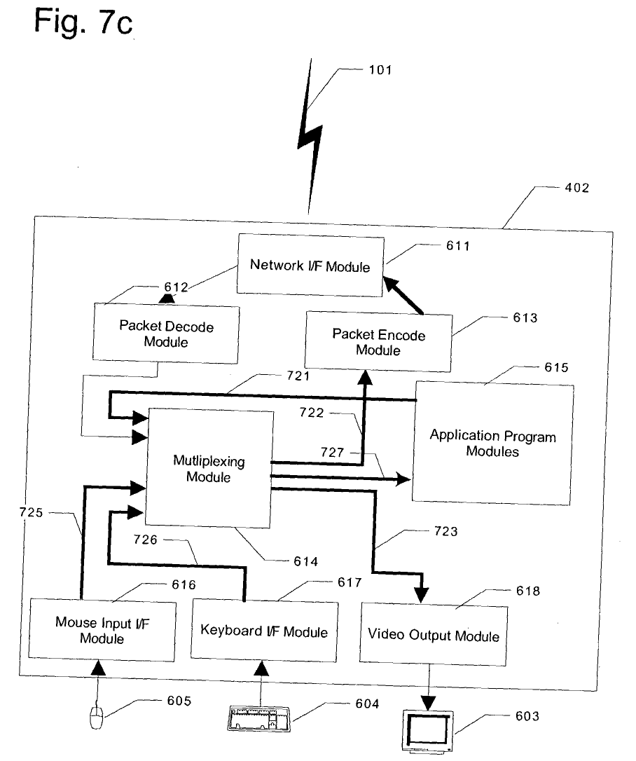

The operation of the individual modules are described below. These modules are used, as discussed in reference to FIG. 7 below to configure the operation of the control unit in various operating modes. These modes correspond to the modes in which the control unit may be used to communicate with the client workstations according to the present invention.

The network interface module 611 receives all data packets that are transmitted over the communications network from the control unit 401. Only packets with the IP address corresponding to the IP address for this particular workstation are processed by the module 611 to use by other modules within the workstation 402. The network interface module 611 also transmits all data packets that are transmitted over the communications network to the control unit 401.

The packet encode module 612 processes outgoing data packets that are to be transmitted by the network interface module 611 to a control unit 401. This packet encode module 612 typically would be responsible for translating an identifier of a control unit into its IP address. Similarly, the packet decode module 613 processes incoming data packets that are received by the network interface module 411 from a control unit 401. The packet decode module 413 determines if the data corresponds to various types of data, such as video, keyboard commands, mouse commands, or similar command data, that is to be sent to an appropriate module within the control unit 401 for further processing.

The multiplexer module 614 receives data decoded by the packet decode module 613 and routes it to the appropriate module within the workstation 402 that will process the incoming data. The multiplexer module 614 also routes outgoing data from various modules within the workstation 402 to the packet encode module 612 for transmission to a control unit. The operation of the multiplexer module 614 is best understood in light of the examples found within FIG. 7.

The application program module 615 corresponds to any application program that is to be executed on the workstation 402 that may generate output video data that is to be sent to a control unit 401.

The video output module 618 receives video data from either the application program module 615 that is generated within the control unit 401 that has been transmitted over the communications network or that has been generated locally within the client workstation 402. The video output module 618 processes the data into a form that may be displayed upon an external video display device 605. This module 618 may be merely a video buffer and corresponding set of video drivers. This module 618 may alternatively process the video data for inclusion within a smaller window within the image displayed on the external video display device 603. The mouse input interface module 616 receives mouse input commands from an external pointing device such as a mouse, trackball, and digitizing pad 605. This input command is passed to the application program module for use in controlling its operation. Similarly, the keyboard interface module 617 receives input keystroke commands from an external input device such as a keyboard 604 that are also passed to the application program module for use in controlling its operation.

FIGS. 7a-7c illustrates a set of processing modules utilized within a student workstation operating in various data communication modes in accordance with the present invention. FIG. 7a illustrates the operation of the client workstation 402 when it is in a local operating mode. FIG. 7b illustrates the operation of the client workstation 402 when it is in a video and input data packet receiving mode. FIG. 7c illustrates the operation of the client workstation 402 when it is in a video data packet generation mode. Finally in all of these operating modes, the active data transfer path has been indicated with a BOLD line as discussed below.

FIG. 7a illustrates the operation of the client workstation 402 when it is in a local operating mode. In this operating mode, all of the processing and data remains within the client workstation 402 with no data packets being generated or received with the control unit 401. Input commands received from a mouse and keyboard are transmitted via data paths 703 and 704 respectively to the multiplexer module 614. This input data is sent via data path 702 to the application program module 615 for use in its operation. Output data generated by the application program module 615 passes through the multiplexer module 614 using data paths 701 and 703 to reach the video output module 618. The data generated by the application program module 615 is displayed in this operating mode only upon the external video display device 603.

FIG. 7b illustrates the operation of the client workstation 402 when it is in a video and input data packet receiving mode. In this operating mode, the client workstation receives input data and video data from the control unit 401 for use by the application program module 615 and display on an external video display device 603. Program video data is received by the network interface module 611 and transmitted via data paths 711 to the packet decode module 613. When the packet decode module 613 determines that the data is video data, the data is sent to the multiplexer module 614 via data path 712 for routing to the video output module 618 via data path 714. The output module 618 generates the output images presented to the user on the external display device 603. When the packet decode module 613 determines that the data is input data, the data is passed to the multiplexer module 614 via data path 712 for routing to the application program module 615 via data path 713.

FIG. 7c illustrates the operation of the client workstation 402 when it is in a video data packet generation mode. In this operating mode, the video data generated by the application program module 615 is displayed locally as well as transmitted via the network to the control unit 401 for display to a user. Input data received from an external input device such as a mouse 605 and a keyboard 604 are passed via data paths 725 and 726 respectively to the multiplexer module 614. This input data passes through the multiplexer module 614 and is sent to the application program module 615 via data path 727. The application program module 615 generates output data that is to be displayed to users. This output data is sent via data path 721 to the multiplexer module 615. The multiplexer module 615 sends the output data via data path 723 to the video output module 618 for display on the external display device 603. This output data is also sent via data path 722 to the packet encode module 613 for ultimate transmission to the control unit via the network interface module 611.

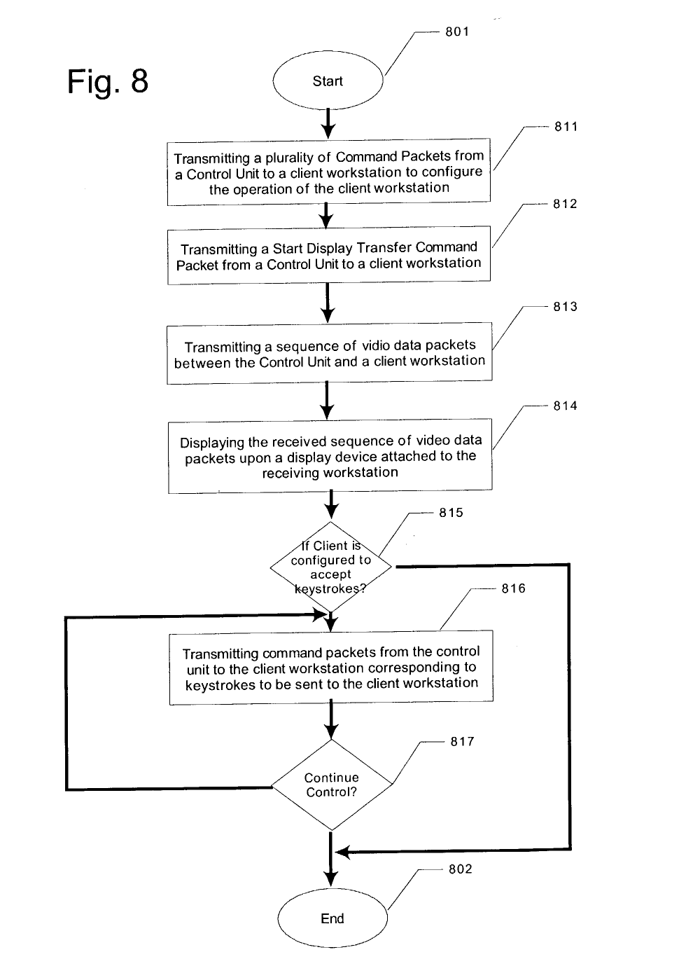

FIG. 8 illustrates an operational flow for the operations of a process for communications between workstations according to an example embodiment of the present invention. In this example embodiment, a control unit will control the operation of a client workstation while viewing the video from the client workstation on a display attached to the control unit. The process begins 801 and proceeds to module 811 in which a plurality of command packets are transmitted from the control unit to the client workstation. This process is needed to configure the operation of the client workstation. The control unit sends the set of commands that are needed to instruct the client work station to both accept input commands corresponding to key strokes that are sent from the control unit to the client workstation as well as to send its display images to the control unit.

Once the client workstation is configured, module 812 transmits a start display transfer command to inform the client workstation that its output video image is now also to be sent over the network to the control unit. The receipt of this command initiates the process of sending the sequence of images as a video data stream performed in module 813. In this example embodiment, the sequence of video data packets are being sent from the client workstation to the control unit. Of course, one skilled in the art will recognize that a set of images that are generated by the control unit and sent to the client work station may also occur in this module 813 without deviating from the spirit and scope of the present invention as recited in the attached claims.

Once the video data packets are received by the control unit, the images are displayed upon an attached display device connected to the control unit in module 815. As noted above, one skilled in the art will recognize that a set of images may also be received by the client workstation from the control unit for the display attached to the client workstation by this module 813 without deviating from the spirit and scope of the present invention as recited in the attached claims.

Once the images of the processing are being displayed on the display device attached to the control unit, the control unit may generate keystrokes that are sent to the client workstation to control the operation of an application program executing therein. For this operation to occur, test module 815 determines if the client is configured to accept keystroke commands. If not, the processing ends 802.

If test module 815 determines that the client workstation is properly configured, the processing continues with module 816. Module 816 transmits the command packets needed to pass the keystrokes from the control unit to the client workstation. These keystrokes may change the operation of a program on the client workstation. The behavior of the client workstation may be observed on the display device attached to the control unit as the keystrokes are processed.

Test module 817 determines if the processing is to send additional keystrokes from the control unit to the client workstation. If not, the processing ends. If test module 817 determines that additional keystrokes are to be generated and transmitted, the processing returns to module 816 to generate and transmit the desired keystrokes. The processing will remain within this processing loop until the test module 817 determines that the processing should end 802.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

While the above embodiments of the present invention describe a system and method for connecting a plurality of computing systems within an educational setting, one skilled in the art will recognize that the use of the processing system discussed above is merely example embodiments of the present invention. As long as a connection table is used to configure elements of an educational computing system, the present invention would be useable in other data processing systems. It is to be understood that other embodiments may be utilized and operational changes may be made without departing from the scope of the present invention as recited in the attached claims.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. The present invention is presently embodied as a method, apparatus, and a computer data product containing a computer program for configuring a fiber optic circuit and module with a switch. Since many embodiments of the invention can be made without departing from the spirit and scope of the invention, the invention resides in the claims hereinafter appended.

What is claimed is:

1. A system for connecting a plurality of computing systems to a single network for permitting a control unit to control the operation of a client workstation, the system comprising:
a plurality of client workstations;
a control unit for configuring the operation of the plurality of client workstations; and
a communications network for transmission of data and commands between the control unit and the plurality of client workstations, the communications network being a TCP/IP based communications network;
wherein
the control unit selectively displays on a first display device attached to the control unit the images displayed on one of the plurality of client workstations;
each of the plurality of client workstations selectively displays on a client display device attached to each of the plurality of workstations images generated by the control unit; and
each of the plurality of client workstations selectively receives input data generated by an external workstation for use as input to an application program executing on each of the plurality of client workstations;
wherein the external workstation comprises the control unit and any of the plurality of client workstations.

2. The system according to claim 1, wherein the control unit transmits command packets over the communications network to the plurality of client workstations to configure the operation of the client workstations.

3. The system according to claim 2, wherein the control unit transmits a sequence of multimedia packet data over the communications network to the plurality of client workstations for display by the client workstations.

4. The system according to claim 3, wherein the control unit transmits input data generated by input devices attached to the control unit for use as input data by the application program executing on the client workstation.

5. The system according to claim 1 wherein the communications network is a wireless communications network.

6. The system according to claim 5, wherein the wireless communications network uses an RF transmission signal to perform the data communications.

7. The system according to claim 5, wherein the wireless communications network utilizes the IEEE 802.11 communications protocol.

8. The system according to claim 1, wherein the control unit operates in a local operating mode.

9. The system according to claim 1, wherein the control unit operates in a program input data packet generation mode.

10. The system according to claim 1, wherein the control unit operates in a multimedia data packet receiving mode.

11. The system according to claim 1, wherein the control unit operates in a multimedia packet data packet generation mode.

12. The system according to claim 1, wherein the control unit operates in a local operating mode, a program input data packet generation mode, a video packet receiving mode, and a video data packet generation mode.

13. The system according to claim 1, wherein the client workstation operates in a local operating mode.

14. The system according to claim 1, wherein the client workstation operates in a video and input data packet receiving mode.

15. The system according to claim 1, wherein the client workstation operates in a video data packet generation mode.

16. The system according to claim 1, wherein the client workstation operates in a local operating mode, a video data packet generation mode, and a video and input data packet receiving mode.

17. A method for connecting a plurality of computing systems to a wireless communication network for permitting a control unit to control the operation of a client workstation, the method comprising:
transmitting a plurality of command packets from a control unit to the client workstation to configure the operation of the client workstation;
transmitting a start display transfer command packet from the control unit to the client workstation to initiate the beginning of a set of video data packets between the control unit and the client workstation; and
if the client workstation is configured to accept keystroke command data packets, transmitting a plurality of keystroke command data packets from the control unit to the client workstation;
wherein the keystroke command data packets correspond to input commands submitted to an application program executing on the client workstation.

18. The method according to claim 17, wherein the method further comprises displaying the set of video data packets received by the control unit on a display device attached to the control unit.

19. The method according to claim 17, wherein the method further comprises displaying the set of video data packets received by the client workstation on a display device attached to the client workstation.

20. The method according to claim 18, wherein the keystroke command data packets correspond to keystrokes entered upon a keyboard attached to the control unit.

21. The method according to claim 18, wherein the keystroke command data packets correspond to mouse click commands entered using a pointing device such as a pointing device attached to the control unit.

22. The method according to claim 17, wherein the wireless communications network uses an RF transmission signal to perform the data communications.

23. The method according to claim 22, wherein the wireless communications network utilizes the IEEE 802.11 communications protocol.
